(19) United States
(12) Patent Application Publication
(10) Pub. No.: US 2011/0056980 A1
(43) Pub. Date: Mar. 10, 2011

(54) DUAL-USAGE BEVERAGE DISPENSING SYSTEM

(76) Inventor: James J. Lloyd, Laguna Niguel, CA (US)

(21) Appl. No.: 12/954,832

(22) Filed: Nov. 26, 2010

Related U.S. Application Data
(63) Continuation of application No. 11/506,624, filed on Aug. 18, 2006.
(60) Provisional application No. 60/709,214, filed on Aug. 18, 2005.

(51) Int. Cl. B67D 7/00

(52) U.S. Cl. 222/1

(57) ABSTRACT

The present invention is a dual-usage beverage dispensing system for preparing and delivering a multi-component beverage as a liquid or as a semi-frozen/frozen beverage.

### CROSS REFERENCE TO RELATED APPLICATIONS

This application claims priority to U.S. application Ser. No. 11/506,624, filed Aug. 18, 2006, which is a non-provisional of U.S. provisional patent application No. 60/709,214, filed Aug. 18, 2005, all of which are incorporated herein.

### FIELD OF THE INVENTIONS

The inventions described below relate the field of beverage packaging and dispensing, and in particular, to a portable beverage delivery system.

### BACKGROUND OF THE INVENTIONS

In general, beverages can be divided into single-component and multi-component products. Examples of single-component beverages include soft drinks such as various colas, soda, root beer, water, coffee, tea, wine, beer, etc., while examples of multi-component products include alcoholic drinks containing liquor and mixer such as bourbon and soda, scotch and water, rum and cola, etc. Multi-component products typically contain a relatively small amount of liquor and a relatively large amount of mixer. Making alcoholic cocktail beverages from liquor generally fall into two categories, over ice, or blended.

Because governmental taxation of a packaged alcoholic product such as a bottle of liquor is based on the volume of the bottle as opposed to weight or concentration of liquor present, beverage producers cannot afford to sell pre-mixed cocktails since, even though a packaged cocktail container may contain only one ounce of liquor and seven ounces of mixer, taxation would be based on the total of eight, and not one, ounces of liquor. Consequently, a consumer is forced to inconveniently transport at least two separate containers (e.g. liquor and mixer) when taking refreshments to an outside function, and must thereafter locate accommodations that permit a proper mixing and serving procedure. Especially with outdoor functions, such accommodations many times are not available, thereby precluding availability of mixed-beverage products.

During many social functions, guests prefer the availability of mixed-beverage products both over ice and blended. Providing mixed-beverage products over ice and blended at social function also requires locating accommodations that permit a proper mixing and serving procedure. Further, blended mixed-beverage products necessitate the use of mixing equipment such as blenders as well as ice and refrigeration equipment. Many time, especially with outdoor functions, mixing equipment, ice, and accommodations for proper serving are not available precluding the availability of mixed-beverage products over ice or blended/frozen.

In view of the obstacles in providing mixed-beverage products over ice and blended, it is apparent that a need exists for convenient packaging that allows carriage of mixer components of a multi-component beverage with integral mixing and dispensing capabilities as part of the packaging for final production of a mixed-beverage product capable of being served over ice or blended.

### SUMMARY

The present invention is a dual-usage beverage dispensing system for preparing and delivering a multi-component beverage as a liquid or as a semi-frozen/frozen beverage. The dual-usage beverage dispensing system comprises a housing with a mixing chamber disposed therein for mixing the individual components of the beverage to form the final beverage product. The chamber has a closeable introduction aperture through which the individual components can enter the chamber. The introduction aperture is constructed to further serve as a first blended dispensing aperture for blended mixed-beverages. The mixing chamber further contains a closeable exit aperture through which the beverage can be dispensed for over ice serving. The mixing chamber may also be provided with a second blended dispensing aperture. The housing has an opening in substantial alignment with the exit aperture through which the exit aperture of the container is accessible and through which the beverage can be dispensed. When the mixing chamber is provided with a second blended dispensing aperture, the housing is also provided with a second opening in substantial alignment with the second blended dispensing aperture through which the blended dispensing aperture of the container is accessible and through which the beverage can be dispensed.

The portable delivery system permits preparation and delivery of a multi-component beverage through interaction of components when desired. The system is capable of serving beverages for over ice consumption. Further, the mixing chamber is capable of dispensing blended multi-component beverages. In this manner a singly-packaged system accomplishes convenient on-site generation of a multi-component beverage capable of being served over ice or blended which otherwise may not practically be packageable or transportable.

### BRIEF DESCRIPTION OF THE DRAWINGS

FIG. 1 shows a dual-usage beverage dispensing system.

FIG. 2 shows a dual-usage beverage dispensing system with a second blended dispensing aperture.

FIG. 3 shows the dual-usage beverage dispensing system in use dispensing multi-component beverages.

FIG. 4 shows the dual-usage beverage dispensing system in use dispensing blended/frozen multi-component beverages.

FIG. 5 shows the dual-usage beverage dispensing system with a slidable housing lid slidably disposed within the housing.

FIG. 6 shows the dual-usage beverage dispensing system with a slidable housing lid slidably disposed within the housing and adapter and a piston rod coupled to the lid.

### DETAILED DESCRIPTION OF THE INVENTIONS

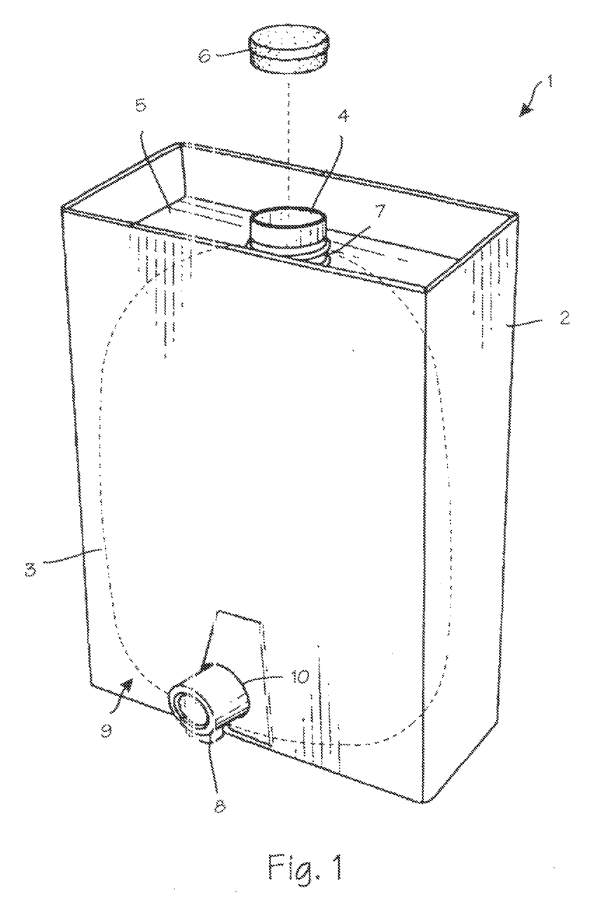

FIG. 1 shows a dual-usage beverage dispensing system 1. The dual-usage beverage dispensing system comprises a housing 2 for housing a flexible-walled mixing chamber 3. The housing may be manufactured from cardboard. The mixing chamber is leak proof and can be constructed of a polymer such as polyethylene. The mixing chamber is typically constructed from a sealed bag.

A top opening or introduction aperture 4 is dispose on the mixing chamber and permits liquid introduction into the mixing chamber upon removal of a conventional friction-fit lid 5. The introduction aperture may be provided with a threaded screw cap 6 or a valve to prevent liquids from exiting through the introduction aperture when not desired. The introduction aperture is sized and dimensioned to function as a blended dispensing aperture and permit the dispensing of blended frozen or semi-frozen multi-component beverages. Blended frozen or semi-frozen multi-component beverages contain both liquids and ice crystals. The introduction aperture is accommodated by an introduction cut 7 out or first cut out in the housing.

An exit aperture 8 having a standard hand-operable valve spout 11 is disposed near the bottom 9 of the chamber and is accommodated by a spout cut out 10 or second opening through the housing to allow controlled exit of liquid from the mixing chamber. The exit aperture may or may not be sized and dimensioned to dispense blended frozen or semi-frozen multi-component beverages. In FIG. 1, the exit aperture is sized and dimension to permit the dispensing of liquids only.

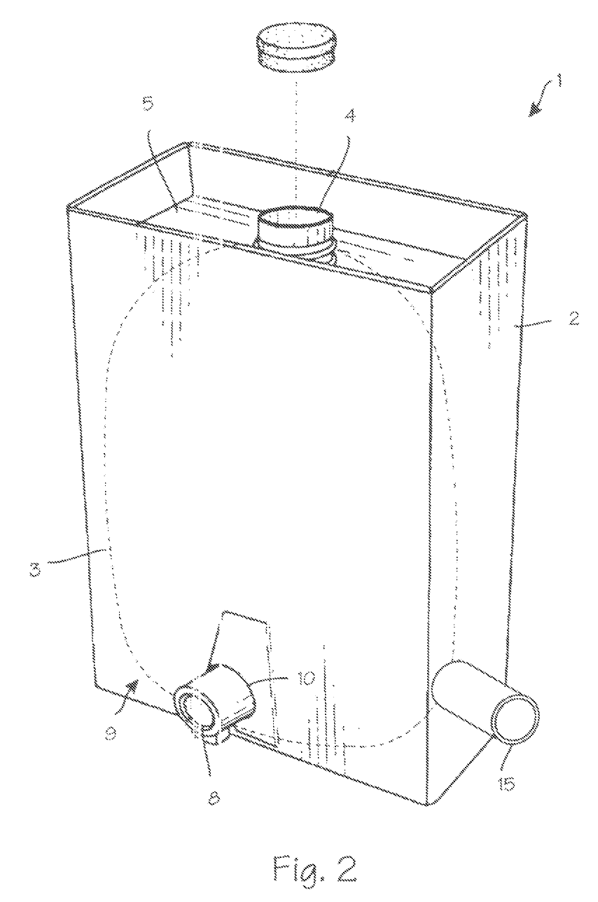

As shown in FIG. 2, the dual-usage beverage dispensing system may be provided with a second exit aperture 15 disposed near the bottom of the chamber. The second exit aperture can be provided with a valve or a threaded screw cap. The second blended dispensing aperture is accommodated by a second spout cut out 16 through the housing to allow controlled exit of frozen or semi-frozen liquid from the mixing chamber that would be unable to exit through the first exit aperture.

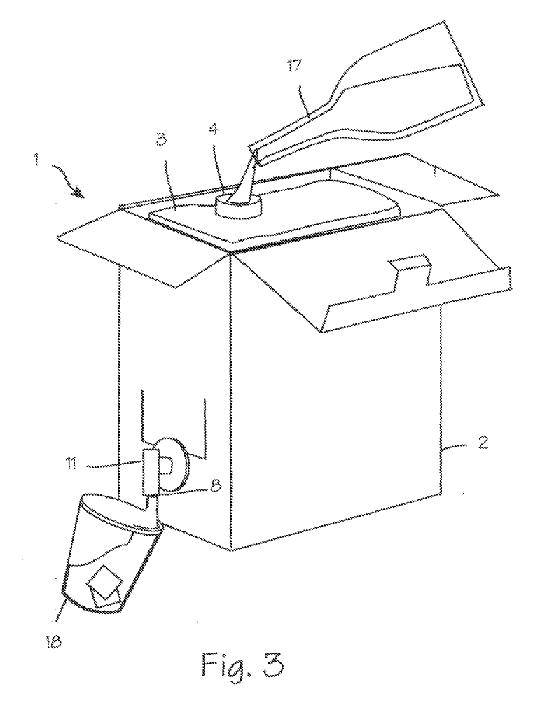

When the dual-usage beverage dispensing system is in use, a user of the system introduces all components of a desired beverage into the mixing chamber through the introduction aperture. Typically, the mixing chamber is provided with one or more mixer components such as margarita mix disposed therein and the user adds an alcoholic component 17 to the mixer such as tequila. When all components of a desired beverage are introduced into the mixing chamber, the user mixes the components together by lightly shaking the mixing container. Once the mixing is completed, the user is able to dispense the completed beverage through the exit spout into a glass 18 or other drinking container for over ice consumption, such as a margarita on the “rocks” as depicted in FIG. 3.

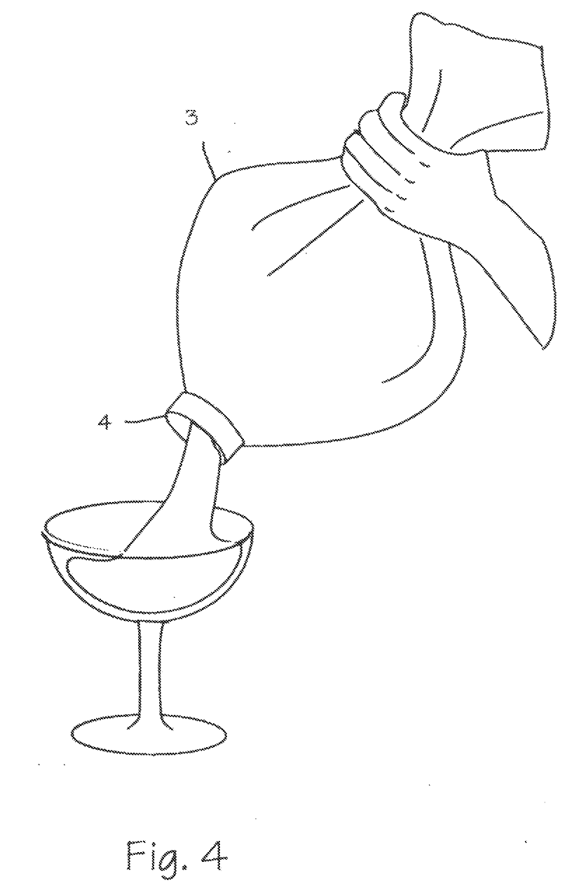

The dual-usage beverage dispensing system is further capable of serving blended/frozen multi-component beverages such as a frozen margarita. When in use, a user of the system opens the introduction aperture and introduces all components of a desired beverage into the mixing chamber through the introduction aperture. When all components of a desired beverage are introduced into the mixing chamber, the user closes the introduction aperture and mixes the components together. The user then places the mixing chamber into a cold environment having a temperature below the freezing point of water, typically a household freezer. The mixing chamber with the components of a desired beverage therein is kept in the freezer for a period of time capable of semi-freezing or freezing the beverage. Once a suitable amount of ice crystals have formed in the multi-component beverage, the mixing chamber is removed from the freezer. As shown in FIG. 4, a user is then able to dispense the blended/frozen multi-component beverage having liquid and ice through the introduction aperture by use of gravity or squeezing the mixing chamber.

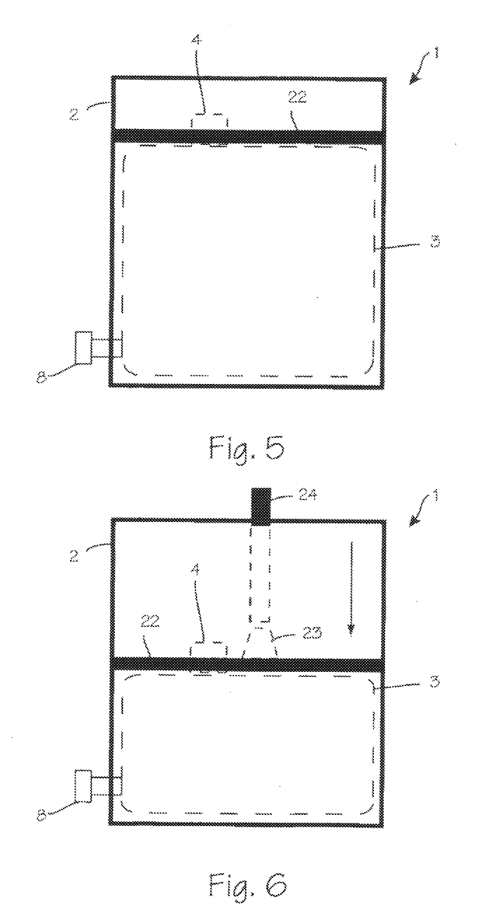

FIG. 5 shows the dual-usage beverage dispensing system with a slidable housing lid 22 slidably disposed within the housing. The slidable top of the housing functions as a piston and the housing serves as a cylinder. A user may depress the slidable lid which then compresses the chamber facilitating the dispensing of a multi-component beverage through the first or second exit aperture. An adapter 23 may be disposed on the housing lid. The adapter is sized and dimension to functionally engage and receive a handle 24 that can function as a piston rod. The handle can be attached to the lid to further assist a user in depressing the lid in a downward motion as shown in FIG. 6.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A method of forming and dispensing a semi-frozen multi-component beverage with a portable beverage delivery system, comprising:
providing a delivery system having a housing with a compartment, the housing having a first opening and a second opening, and a mixing chamber having a mixer beverage therein, the mixing chamber disposed with the compartment of the housing and having a closeable introduction aperture and a closeable exit aperture respectively exposed through the first opening and the second opening of the housing;
opening the introduction aperture of the mixing chamber;
pouring a portion of an alcoholic beverage from a container into the mixing chamber through the introduction aperture;
closing the introduction aperture of the mixing chamber;
intermixing the mixer beverage and the portion of the alcoholic beverage together to form the multi-component beverage within the mixing chamber;
placing the mixing chamber in a freezer for a period of time to form the semi-frozen multi-component beverage;
removing the mixing chamber from the freezer;
dispensing the multi-component beverage through the exit aperture of the mixing chamber; and
dispensing the semi-frozen multi-component beverage through the introduction aperture of the mixing chamber.

2. The method of claim 1, wherein the housing is constructed of cardboard.

3. The method of claim 1, wherein the mixing chamber is a flexible plastic bag structure.

4. The method of claim 1, wherein the exit aperture comprises a valve for selectively opening and closing the exit aperture.

5. The method of claim 1, wherein the exit aperture comprises a valve for selectively opening and closing the exit aperture.

6. The method of claim 1, wherein dispensing the multi-component beverage through the exit aperture of the mixing chamber is accomplished by gravity force.

7. A method of forming and dispensing a semi-frozen multi-component beverage with a portable beverage delivery system, the portable delivery system having a housing with a compartment, the housing having a first opening and a second opening, and a mixing chamber having a mixer beverage therein, the mixing chamber disposed with the compartment of the housing and having a closeable introduction aperture and a closeable exit aperture respectively exposed through the first opening and the second opening of the housing, the method comprising:
opening the introduction aperture of the mixing chamber;
pouring a portion of an alcoholic beverage into the mixing chamber through the introduction aperture;
closing the introduction aperture of the mixing chamber;
intermixing the mixer beverage and the portion of the alcoholic beverage together to form the multi-component beverage within the mixing chamber;
freezing the mixing chamber for a period of time capable of forming the semi-frozen multi-component beverage;
dispensing the multi-component beverage through the exit aperture of the mixing chamber; and
dispensing the semi-frozen multi-component beverage through the introduction aperture of the mixing chamber by squeezing the mixing chamber.

8. A method of forming and dispensing a semi-frozen multi-component beverage with a portable beverage delivery system, the portable delivery system having a housing with a compartment, the housing having a first opening and a second opening, and a mixing chamber having a mixer beverage therein, the mixing chamber disposed with the compartment of the housing and having a closeable introduction aperture and a closeable exit aperture respectively exposed through the first opening and the second opening of the housing, the method comprising:
pouring a portion of an alcoholic beverage into the mixing chamber through the introduction aperture;
shaking the mixing chamber to intermix the mixer beverage and the portion of the alcoholic beverage together to form the multi-component beverage within the mixing chamber;
freezing the mixing chamber for a period of time capable of forming the semi-frozen multi-component beverage;
dispensing the multi-component beverage through the exit aperture of the mixing chamber by pressing the mixing chamber; and
dispensing the semi-frozen multi-component beverage through the introduction aperture of the mixing chamber by squeezing the mixing chamber.
